(19) United States
(12) Patent Application Publication
(10) Pub. No.: US 2012/0230639 A1
(43) Pub. Date: Sep. 13, 2012

(54) OPTICAL FIBER

(75) Inventors: Toshiki TARU, Yokohama-shi (JP); Takuji NAGASHIMA, Yokohama-shi (JP); Kazuya KUWAHARA, Yokohama-shi (JP)

(73) Assignee: SUMITOMO ELECTRIC INDUSTRIES, LTD., Osaka-shi (JP)

(21) Appl. No.: 13/416,000

(22) Filed: Mar. 9, 2012

(30) Foreign Application Priority Data
Mar. 10, 2011 (JP) 2011-053251

(51) Int. Cl. G02B 6/032

(52) U.S. Cl. 385/125

(57) ABSTRACT

An easily manufacturable optical fiber that has desired properties includes a core region made of a glass, a cladding region made of a glass surrounding the core region and having a first viscosity at a drawing temperature, and a jacket region made of a glass surrounding the cladding region and having a second viscosity that is lower than the first viscosity at the drawing temperature. A plurality of holes that are surrounded by the glass of the cladding region and the glass of the jacket region are circumferentially arranged in a cross section that is perpendicular to a fiber axis and extend along the fiber axis, and 50% or more of the glass surrounding each of the plurality of holes is the glass of the cladding region.

### BACKGROUND OF THE INVENTION

1. Field of the Invention

The present invention relates to optical fibers.

2. Description of the Related Art

An optical fiber described in U.S. Pat. No. 7,228,040B (Patent Document 1) includes a core region, a cladding region surrounding the core region, a jacket region surrounding the cladding region, and multiple holes circumferentially arranged in a cross section that is perpendicular to the fiber axis. The multiple holes extend along the fiber axis. Such an optical fiber is called a hole-assisted optical fiber.

The properties of the hole-assisted optical fiber, such as cut-off wavelength and bending loss, are greatly dependent on the number, arrangement, size, and shape of holes. For example, the cut-off wavelength is long when the hole size is large, while the bending loss is large when the hole size is small. That is, the cut-off wavelength and the bending loss have a trade-off relationship with regard to the hole size, and thus a preferable range of the hole size is subject to limitation.

It is thus important to form a hole-assisted optical fiber in accordance with designed parameters, such as hole size and hole shape. The hole size is controlled by adjusting the pressure inside the hole or the like at the time of drawing. At this time, the hole diameter is almost proportional to the pressure.

Japanese Unexamined Patent Application Publication (Translation of PCT Application) No. 2005-538029 (Patent Document 2) and Japanese Unexamined Patent Application Publication No. 2002-277667 (Patent Document 3) disclose inventions of optical fibers in which holes are prevented from being deformed. The optical fiber described in Patent Document 2 has holes in a highly viscous cladding region made of a glass that has a higher viscosity than that of a glass of a jacket region at a drawing temperature. The optical fiber described in Patent Document 3 has holes in a highly viscous core region made of a glass that has a higher viscosity than that of a glass of a cladding region at a drawing temperature. The inventions disclosed in Patent Documents 2 and 3 are made to provide optical fibers in which the holes of the optical fibers obtained by drawing are prevented from being deformed by being arranged in the highly viscous regions.

However, a technique of controlling the hole size by adjusting the pressure inside the hole at the time of drawing is not easy, and thus controlling the hole size to a desired size on the order of 0.1 μm is difficult. Even in the case where holes are arranged in a highly viscous region as in the inventions disclosed in Patent Documents 2 and 3, the holes are more likely to be deformed at the time of drawing if the distance between two adjacent holes is short in the preform or the preform has holes of various sizes. In any case, manufacturing optical fibers having desired properties is not easy.

### SUMMARY OF THE INVENTION

An object of the present invention is to provide an easily manufacturable optical fiber that has desired properties.

To solve the above problems, provided is an optical fiber that includes (1) a core region made of a glass, (2) a cladding region made of a glass that surrounds the core region and having a first viscosity at a drawing temperature, and (3) a jacket region made of a glass that surrounds the cladding region and having a second viscosity that is lower than the first viscosity at the drawing temperature. A plurality of holes surrounded by the glass of the cladding region and the glass of the jacket region are circumferentially arranged in a cross section that is perpendicular to the fiber axis and extend along the fiber axis, and 50% or more of the glass surrounding each of the plurality of holes is the glass of the cladding region.

The optical fiber according to the present invention can be easily manufactured while having desired properties.

### BRIEF DESCRIPTION OF THE DRAWINGS

FIG. 1 is a sectional view of an optical fiber according to a first embodiment of the present invention, taken perpendicularly to the fiber axis of the optical fiber.

FIG. 2 is a schematic diagram illustrating a refractive index profile of the optical fiber according to the first embodiment, taken along the broken line of FIG. 1.

FIG. 3 is a sectional view of an optical fiber according to a second embodiment of the present invention, taken perpendicularly to the fiber axis of the optical fiber.

FIG. 4 is a schematic diagram illustrating a refractive index profile of the optical fiber according to the second embodiment, taken along the broken line of FIG. 3.

FIG. 5 schematically illustrates how a normalized hole diameter changes in a neck-down portion while a preform is being drawn.

FIG. 6A is a sectional view of a preform having two adjacent holes of different sizes, and FIG. 6B schematically illustrates the size of resultant holes in an optical fiber obtained by drawing the preform.

FIGS. 7A and 7B illustrate the anisotropy of deformation of holes in the optical fiber according to an embodiment of the present invention.

FIG. 8 is a graph illustrating how properties of the optical fiber are changed by changing the hole size while the pressure that is applied during the drawing process is being adjusted.

### DESCRIPTION OF THE PREFERRED EMBODIMENTS

Hereinbelow, embodiments of the present invention will be described with reference to the drawings. The drawings are provided for illustration, and not for restricting the scope of the invention. Throughout the drawings, like reference numerals denote like components and redundant description thereof is not given. The dimensional ratio in each drawing is not always exact.

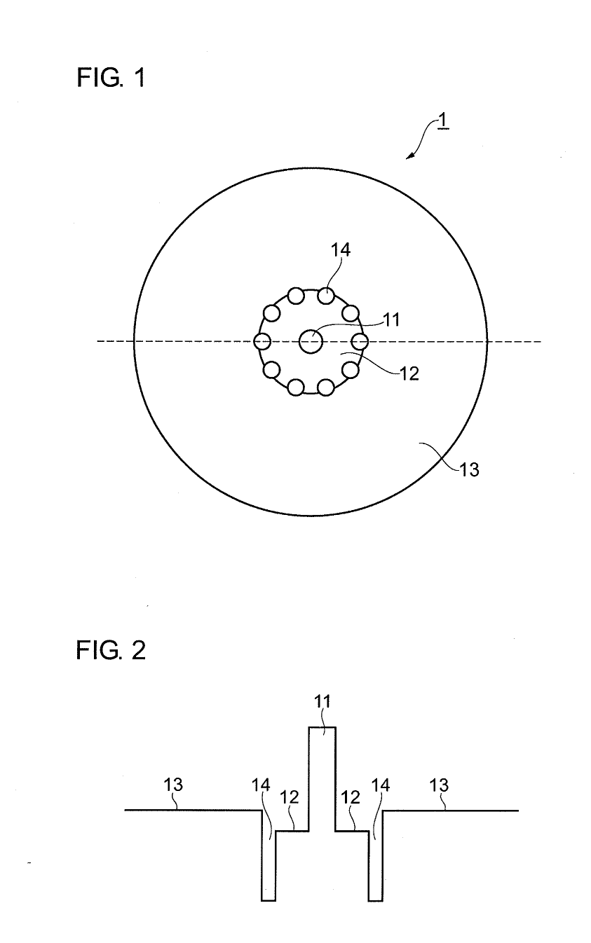

FIG. 1 is a sectional view of an optical fiber 1 according to a first embodiment of the present invention, taken perpendicularly to the fiber axis of the optical fiber. FIG. 2 is a schematic diagram illustrating a refractive index profile of the optical fiber 1 taken along the broken line of FIG. 1. The optical fiber 1 includes a core region 11, a cladding region 12 surrounding the core region 11, a jacket region 13 surrounding the cladding region 12, and multiple (ten, in FIG. 1) holes 14 circumferentially arranged in a cross section that is perpendicular to the fiber axis and extending along the fiber axis. The core region 11, the cladding region 12, and the jacket region 13 are each made of a glass.

The optical fiber 1 is manufactured in the following method. Firstly, a glass rod is produced that includes a silica glass core containing germanium dioxide (GeO₂) and a cladding not containing GeO₂. In the production of the glass rod, a glass particle deposit is produced and subjected to consolidation to be transparent by vapor-phase axial deposition (VAD). The glass rod is extended so as to have an appropriate shape, and then a glass, which serves as the jacket region, is attached to the periphery of the extended glass rod. The attachment of the jacket region is performed by depositing soot and consolidating by VAD or outside vapor phase deposition (OVD). The attachment may be performed by a process such as a jacket collapse in which a separately prepared silica glass pipe is used. Holes are formed with a drill at predetermined positions in the glass rod having the jacket region attached thereto, and thus the production of a preform is complete.

The preform is drawn to form an optical fiber 1. Here, drawing the preform is performed while the pressure in the preform holes is adjusted such that the optical fiber 1 has holes 14 of a predetermined size. For example, the size of the holes 14 at a drawing start end portion is checked. If the checked size of the holes 14 is smaller than a desired size, the pressure is increased, whereas if the size of the holes 14 is larger than the desired size, the pressure is decreased to obtain a target hole diameter.

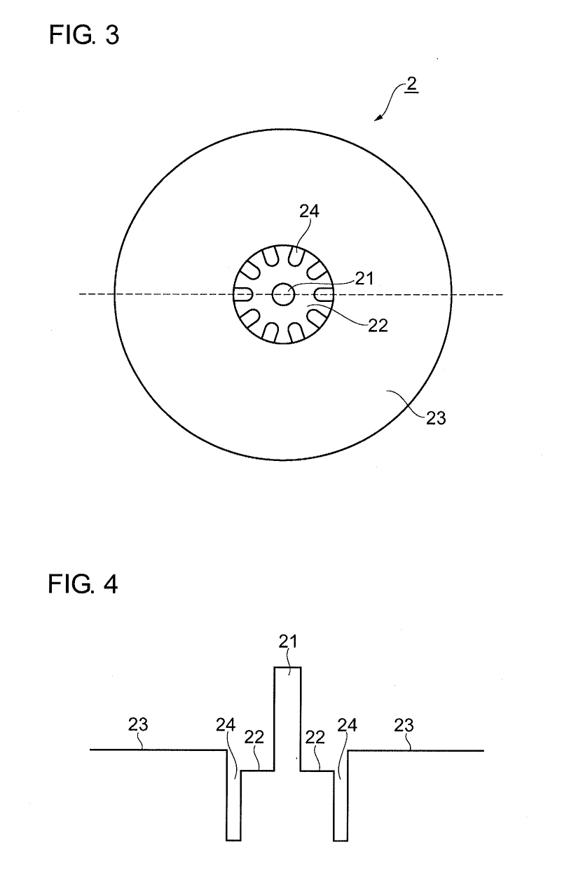

FIG. 3 is a sectional view of an optical fiber 2 according to a second embodiment of the present invention, taken perpendicularly to the fiber axis of the optical fiber 2. FIG. 4 is a schematic diagram illustrating a refractive index profile of the optical fiber 2 taken along the broken line of FIG. 3. The optical fiber 2 includes a core region 21, a cladding region 22 surrounding the core region 21, a jacket region 23 surrounding the cladding region 22, and multiple (ten, in FIG. 3) holes 24 circumferentially arranged in a cross section that is perpendicular to the fiber axis and extending along the fiber axis. The core region 21, the cladding region 22, and the jacket region 23 are each made of a glass.

The optical fiber 2 is manufactured in the following method. Firstly, a glass rod is produced that includes a silica glass core containing GeO₂ and a cladding not containing GeO₂. Multiple grooves that extend in the axial direction are formed on the outer periphery of the glass rod. The glass rod is subjected to the jacket collapse or rod-in collapse process to form a preform. At this time, the jacket collapse or the rod-in collapse process is performed such that the grooves in the glass rod are left to serve as holes 24 of the optical fiber 2. The preform is then drawn to form an optical fiber 2.

In each of the optical fibers 1 and 2, the viscosity of the glass of the jacket region is smaller than the viscosity of the glass of the cladding region at the drawing temperature. In addition, the refractive index of the cladding region is lower than the refractive index of the core region, and the refractive index of the jacket region is higher than the refractive index of the cladding region. Such relationships between the regions with regard to the viscosity and the refractive index can be achieved by selecting an additive and adjusting the amount of the additive to be added into a preform. For example, the viscosity of a silica glass can be lowered by adding chlorine or fluorine. The above relationships are achieved by, for example, adding a smaller amount of chlorine to the glass of the cladding region than the amount of chlorine added to the glass of the jacket region.

In each of the optical fibers 1 and 2, the multiple holes are surrounded by the glass of the cladding region and the glass of the jacket region, and 50% or more of the glass surrounding each of the multiple holes is the glass of the cladding region. In the case of the optical fiber 1, the holes are drilled in the preform at such positions that 50% or more of the glass surrounding each of the multiple holes 14 is the glass of the cladding region 12. In the case of the optical fiber 2, 50% or more of the glass surrounding each of the multiple holes 24 is inevitably constituted by the glass of the cladding region 22 by the above described method of producing the preform.

A concrete example of the optical fiber according to each of the first and second embodiments is as follows. The core region is made of a silica glass containing GeO₂, the cladding region is made of a silica glass containing chlorine (less than 0.2 wt %), and the jacket region is made of a silica glass containing chlorine (more than 0.2 wt %). The relative refractive index difference of the core region is 0.30 to 0.40%, the relative refractive index difference of the cladding region is 0 to 0.02%, and the relative refractive index difference of the jacket region is more than 0.02%. The relative refractive index difference Δn is defined by

$$Δ n = \frac{{n}_{object}^{2} - {n}_{pure silica}^{2}}{2 {n}_{object}^{2}} .$$

In this equation, n_{pure silica} denotes the refractive index of a pure silica glass, and n_{object} denotes the refractive index of either the core region, the cladding region, or the jacket region. The diameter of the core region is 7.0 to 8.0 μm, the diameter of the cladding region is 3 to 5 times as large as the diameter of the core region, and the diameter of the jacket region is 125 μm. The number of holes is ten.

It is preferable that the concentration of chlorine in the glass of the cladding region be larger than 0.05 wt %. Since the cladding region is an optical cladding through which a certain amount of light is guided, it is preferable that the cladding region have a low optical absorption loss and be a glass that is dehydrated with a chloride dehydrator. The glass obtained in this manner consequently has a certain concentration of chlorine.

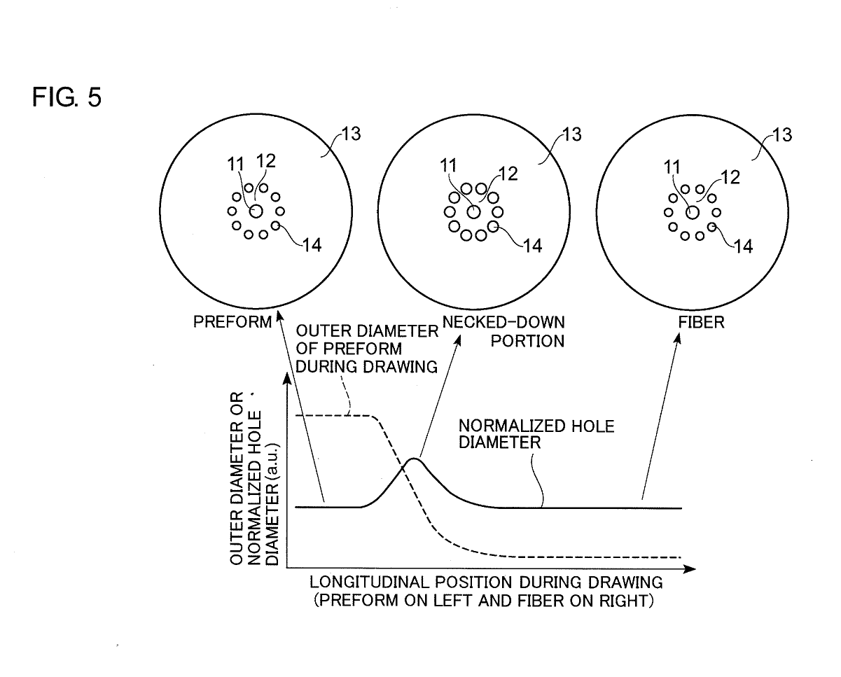

Now, a description will be given of the change in hole diameter during manufacturing of an optical fiber by drawing the preform having holes. In the process of drawing the preform to form an optical fiber, the size of the holes decreases as the outer diameter of the preform decreases. Here, the size of holes relative to the outer diameter of the preform (hereinafter referred to as a “normalized hole diameter”) differs at various positions in a necked-down portion with effects of the surface tension, applied pressure, drawing tension, and other factors. For example, when the normalized hole diameter of the preform and the normalized hole diameter of the optical fiber are the same (that is, when the section of the preform and the section of the optical fiber are similar figures), the normalized hole diameter temporarily becomes larger in the necked-down portion, then becomes smaller, and finally becomes a target diameter, as illustrated in FIG. 5. FIG. 5 schematically illustrates how the normalized hole diameter changes in the necked-down portion during the drawing process of the preform.

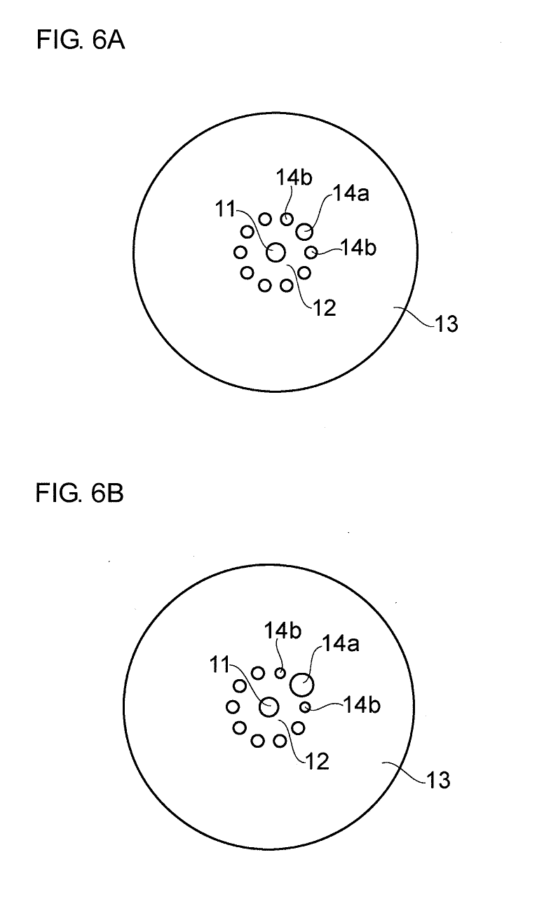

In the drawing process of the preform having multiple holes, a desired structure may not be obtained if holes are deformed in terms of shape or size due to the interaction of two adjacent holes. The deformation due to the interaction becomes noticeable when the two adjacent holes have different sizes or when the distance between the two adjacent holes is short. FIG. 6A is a sectional view of a preform having two adjacent holes 14a and 14b of different sizes. FIG. 6B schematically illustrates the change in hole size in an optical fiber obtained by drawing the preform. The normalized hole diameter of the hole 14a that is large at the preform stage becomes larger at the optical fiber stage, while the normalized hole diameter of the holes 14b that are adjacent to the hole 14a becomes smaller at the optical fiber stage. In view of the above, it is preferable that the holes have a uniform size as much as possible at the preform stage, but making the hole size completely uniform is difficult due to unevenness during the production of preforms.

In the structure of the optical fiber according to an embodiment of the present invention, 50% or more of the glass surrounding each of the holes is the highly viscous glass of the cladding region, and thus the holes do not easily deform toward the cladding region. The remaining glass surrounding each hole is the low-viscous glass of the jacket region, and thus the holes are more likely to deform toward the jacket region.

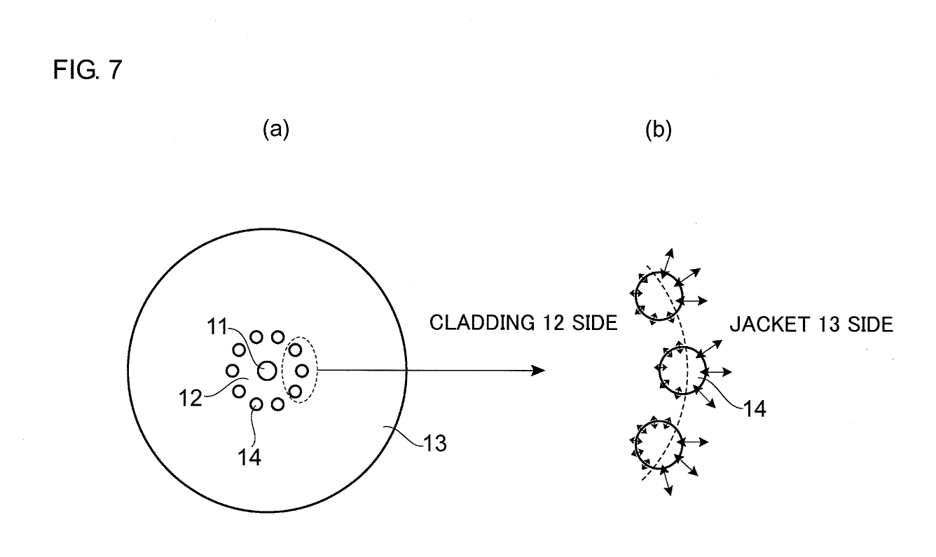

FIGS. 7A and 7B illustrate the anisotropy of deformation of holes in the optical fiber according to an embodiment of the present invention. FIG. 7B illustrates an enlargement of part of the region illustrated in FIG. 7A. The length of double-sided arrows illustrated in FIG. 7B indicates the amount of deformation. In available optical fibers including the optical fibers described in Patent Documents 2 and 3, holes deform (expand or contract) isotropically, whereas in the optical fibers in the embodiments of the present invention, holes mostly deform toward a region that is on the outer side in the radial direction. Since holes are less likely to circumferentially expand in the optical fiber according to the embodiment of the present invention, the holes can be prevented from being deformed by the interaction between two adjacent holes. In order to allow the holes to deform toward the jacket region, it is preferable that 10% or more of the glass surrounding each of the multiple holes be the glass of the jacket region.

Other effects of the optical fiber according to an embodiment of the present invention will be described now. The hole size of an optical fiber manufactured by drawing a preform having holes is the key to obtaining desired optical properties of the optical fiber. In the actual manufacturing, in order to reduce the variation in normalized hole diameter among preform lots, the pressure to be applied during the drawing process is adjusted for each preform lot such that the hole size becomes a desired value. Specifically, as described above, when the normalized hole diameter in a preform is large, the pressure applied during the drawing process is reduced so that the hole size in the optical fiber is reduced. On the other hand, when the normalized hole diameter of a preform is small, the pressure applied during the drawing process is increased so that the hole size in the optical fiber is increased. In this case, the normalized hole diameter of the preform and the normalized hole diameter of the optical fiber may differ from each other.

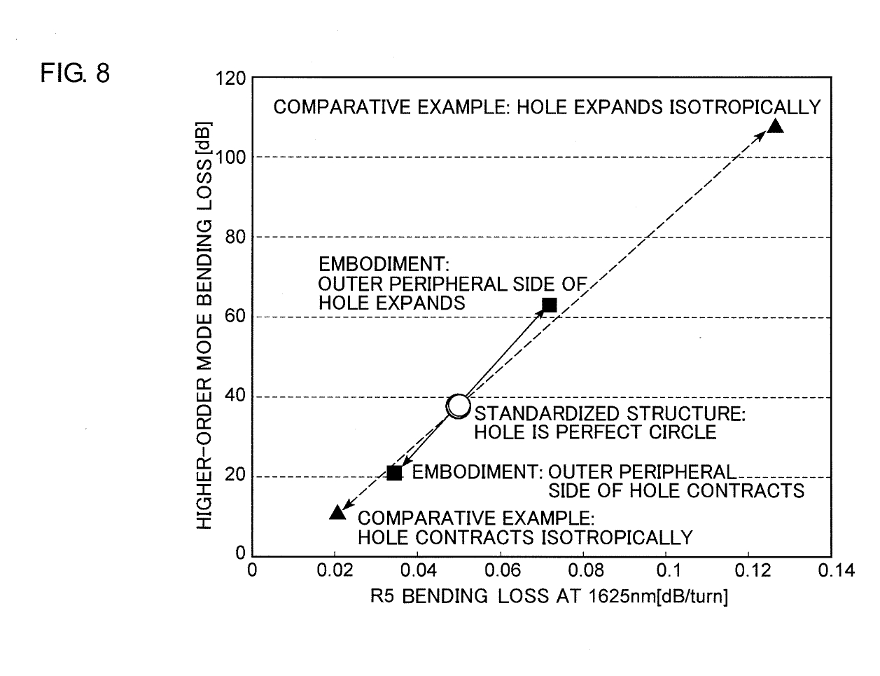

FIG. 8 is a graph illustrating how properties of the optical fiber are changed by changing the hole size while the pressure applied during the drawing process is being adjusted. The horizontal axis represents the bending loss, and the vertical axis represents the higher-order mode bending loss at cable cut-off wavelength. For example, target optical fiber properties are as follows: a bending loss (R5 at 1,625 nm) is 0.1 dB/turn or lower, and a higher-order mode bending loss is 19.4 dB or higher.

In comparison between cases (solid triangle and solid square) where holes according to Comparative Example and the embodiments are deformed so as to have the same sectional area, a change in the hole size according to the embodiments in which the hole size relatively increases in the radial direction affects the properties less than that of Comparative Example in which the hole size uniformly increases in the radial direction and in the circumferential direction. This is because the properties, such as the cut-off wavelength and the bending loss, of an optical fiber having this structure are parameters that heavily depend on the distance between adjacent holes. For this reason, the optical fibers according to the embodiments of the present invention have stable optical properties and the production yield of the optical fibers is improved since the effect of the variation in the hole size on the properties of the optical fiber can be reduced.

As seen in FIG. 8, the effect of the change in the hole size according to the embodiments on the properties is small. Thus, the optical fibers according to the embodiments are advantageous in that, when the optical properties are calculated on the basis of the hole size, the calculation is less affected by a measurement error of the hole size.

What is claimed is:

1. An optical fiber comprising:
a core region made of a glass;
a cladding region made of a glass that surrounds the core region and having a first viscosity at a drawing temperature; and
a jacket region made of a glass that surrounds the cladding region and having a second viscosity that is lower than the first viscosity at the drawing temperature,
wherein a plurality of holes surrounded by the glass of the cladding region and the glass of the jacket region are circumferentially arranged in a cross section that is perpendicular to a fiber axis and extend along the fiber axis, and
wherein 50% or more of the glass surrounding each of the plurality of holes is the glass of the cladding region.

2. The optical fiber according to claim 1, wherein a concentration of chlorine in the glass of the cladding region is higher than 0.05 wt %.
